(19) United States
(12) Patent Application Publication
(10) Pub. No.: US 2009/0315900 A1
(43) Pub. Date: Dec. 24, 2009

(54) GENERIC SURFACE MANAGER

(75) Inventors: Oreste Dorin Ungureanu, Duvall, WA (US); Younus Aftab, Bothell, WA (US); Ivan Brugiolo, Bellevue, WA (US); Andrei Baioura, Redmond, WA (US); Yutaka Nakajima, Redmond, WA (US); David R. Blythe, Kirkland, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/144,002

(22) Filed: Jun. 23, 2008

(51) Int. Cl. G06F 13/14; G06T 1/00

(52) U.S. Cl. 345/520; 345/501

(57) ABSTRACT

A method, medium, and system are provided for a generic surface manager which allows graphics surfaces generated according to various existing and/or new graphics protocols to be rendered by a graphics consumer. The generic surface manager functions as an interface between a graphics consumer and one or more applications that generate graphics surfaces. Support is provided for various existing graphics protocols and the generic surface manager can be easily modified to accept surfaces generated according to new graphics protocols. An extensible system is thereby provided that can support a variety of graphics protocols without requiring modifications to be made to the graphics consumer.

### BACKGROUND

Currently, graphics consumers consume content from multiple rendering components and display it as part of a composition tree by rendering logical surfaces based on surface information generated by rendering components and communicated to the graphics consumer. A logical surface is an abstraction that describes the properties of a surface that are independent of its rastersizer specific properties. These properties can be size and dirty regions. Rastersizer specific properties are those that are needed to render the surface; such as: CPU or video memory surface, pixel format, or external handles used to get the pixels in the surface.

Graphics consumers are only able to process surface information that is generated according to one or more predefined graphics protocols. When a new graphics protocol is developed, changes must be made to the graphics consumer to allow for the processing of surface information generated in accordance with the new graphics protocol. Consequently, in order for the graphics consumer to remain compatible with new graphics protocols, updated versions of the graphics consumer must be created each time a new graphics protocol is released.

### SUMMARY

Methods, systems, and computer-readable media are provided for an extensible system that can support a variety of currently available and as-of-yet undeveloped graphics protocols without requiring modifications to be made to a graphics consumer. In one aspect of the invention, methods and computer-storage media for providing an interface between one or more logical surfaces and a graphics consumer are presented. The lifetime of graphics surfaces are tracked and associated to composition nodes in a composition tree in the graphics consumer. When rendering occurs to a graphics surface by their respective owning applications, the graphics consumer is notified.

In a second aspect, a system is provided that comprises a rendering component for generating graphics information and communication between the rendering component and a generic surface manager component. Rendering components communicate with the generic surface manager to obtain surface information and then render their content to the logical surfaces in accordance with a graphics protocol. The logical surfaces are then consumed by the graphics consumer and rendered as part of a composition tree.

In a third aspect, a method for providing an interface between one or more surfaces and a graphics consumer is provided. A rendering component generates surfaces and an identifier is assigned to each surface. The lifetime of the surfaces is tracked by the generic surface manager component and the surfaces are associated with composition nodes in a graphics consumer. The generic surface manager component monitors the surfaces generated by the rendering component and upon determining that the surfaces have been modified, notifies the graphics consumer accordingly.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a block diagram illustrating an overview of a system in accordance with an embodiment of the invention;

FIG. 2 is a diagram illustrating an exemplary system, according to an embodiment of the invention;

FIG. 3 is a diagram illustrating the communication of surface information to a graphics consumer component, according to an embodiment of the invention;

FIG. 4 is a diagram illustrating the communication of information between components of an exemplary system, according to an embodiment of the invention;

FIG. 5 is a block diagram depicting a method for providing a generic interface between one or more surfaces and a graphics consumer in accordance with one embodiment of the invention; and

FIG. 6 is a block diagram depicting a method for providing an interface between one or more surface and a graphics consumer, according to an embodiment of the invention.

### DETAILED DESCRIPTION

Embodiments of the present invention may be embodied as, among other things: a method, system, or computer-program product. Accordingly, the embodiments may take the form of a hardware embodiment, a software embodiment, or an embodiment combining software and hardware. In one embodiment, the present invention takes the form of a computer-program product that includes computer-useable instructions embodied on one or more computer-readable media.

Computer-readable media include both volatile and nonvolatile media, removable and nonremovable media, and contemplates media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

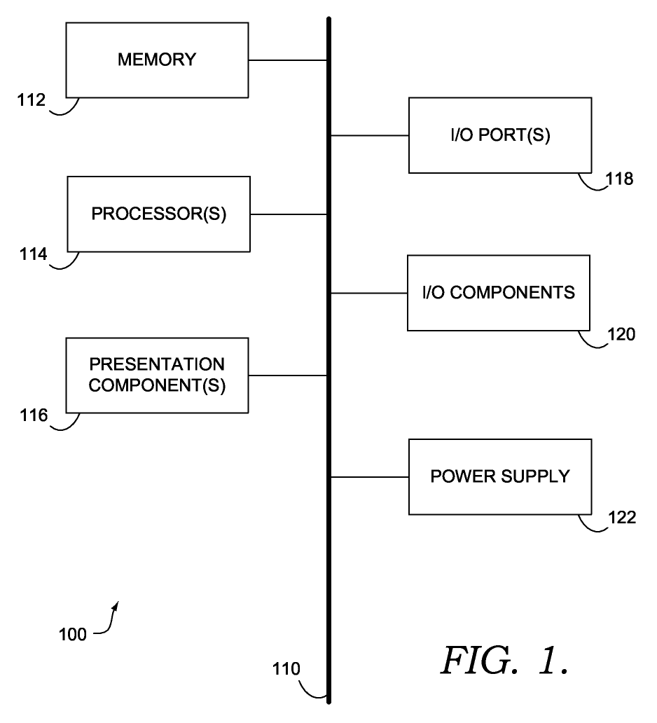

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the illustrated computing environment be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other hand-held device. Generally, program components including routines, programs, objects, components, data structures, and the like, refer to code that performs particular tasks, or implements particular abstract data types. Embodiments of the present invention may be practiced in a variety of system configurations, including hand-held devices, consumer electronics, general-purpose computers, specialty-computing devices, and the like. Embodiments of the present invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices; or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disk drives, and the like. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game advertisement, satellite dish, scanner, printer, wireless device, and the like.

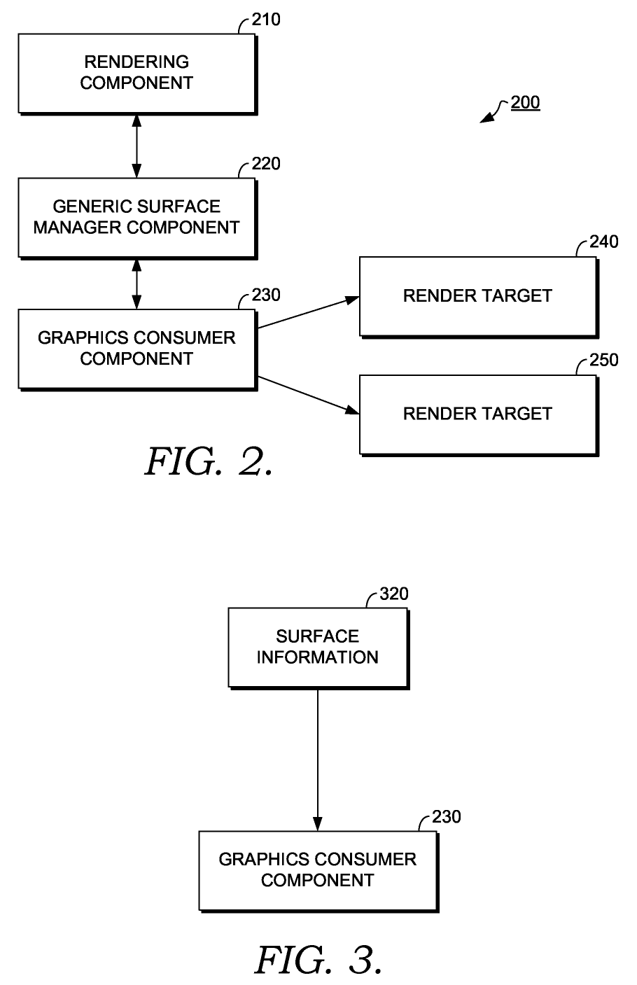

Turning now to FIG. 2, a diagram illustrating an exemplary system is presented, according to an embodiment of the invention. The system 200 includes a rendering component 210, a generic surface manager component 220, a graphics consumer component 230, and render targets 240 and 250. While only two render targets 240 and 250 are depicted, it should be understood that any number of logical surfaces are contemplated in the system 200.

Rendering component 210 can be applications on computing device 100 that generate graphical output for display on render targets 240 and 250. Render targets 240 and 250 can be a logical space or memory allocated on the computing device 100 on which the rendering component 210 produces its graphical result. For example, render targets 240 and 250 can be a window in a user interface of the computing device 100. Rendering component 210 generate surface information and communicate with the generic surface manager component 220.

The graphical output generated by the rendering component 210 can be referred to as surface information or a graphics surface. The surface information can be generated by the rendering component 210 according to one or more graphics protocols. The graphics protocols can be DX or GDI, for example.

The generic surface manager component 220 receives the surface information, interchangeably referred to herein as a “surface,” generated by the rendering component 210, and assigns a unique identifier to the surface and associates it to a composition node in a composition tree on the graphics consumer component 230. The composition tree can have a plurality of composition nodes, with each of the nodes associated with a unique surface.

The generic surface manager component 220 tracks the lifetime of the surface by monitoring the surface to determine when it is created and destroyed. A notification is provided by the generic surface manager component 220 to graphics consumer component 230 when a particular surface is drawn to or modified by the rendering component 210. The notification can include the unique identifier assigned to the particular surface. The generic surface manager component 220 communicates with the rendering component 210 to obtain surface information and then render it onto logical surfaces in accordance with a graphics protocol

The graphics consumer component 230 can be a compositing desktop window manager (DWM), or other type of window manager that composes the surface information generated by the rendering component 210 into the render targets 240 and 250 on the desktop user interface on the computing device 100. As discussed above, the generic surface manager component 220 assigns the surface information generated by the rendering component 210 to a node in a composition tree on the graphics consumer component 230. Accordingly, surface information generated by different rendering components can be assigned to different nodes. Upon receiving the notification from the generic surface manager component 220 that a surface has been modified or drawn to, the graphics consumer component 230 then renders the composition tree and composes the surfaces generated by the one or more rendering components. In this manner, the graphics consumer component 230 composes the desktop user interface of the computing device 100 by composing surface information generated by one or more rendering components. The graphics consumer component 230 consumes logical surfaces and renders them as part of a composition tree.

The generic surface manager component 220 provides an extensible framework for supporting different types of graphics protocols employed by the rendering component 210 as specific graphics protocols are, therefore, effectively decoupled from the graphics consumer component 230.

With the introduction of a rendering component 210 that generates surface information according to a new or different graphics protocol, modifications need only be made to the generic surface manager component 220, and not to the graphics consumer component 230. For instance with the introduction of a rendering component 210 that generates surface information according to the DX 11 protocol, only the generic surface manager component 220 would need modification. The particular types of graphics protocols are, therefore, abstracted from the graphics consumer component 230.

With reference now to FIG. 3, a diagram is presented illustrating the communication of surface information to a graphics consumer component in accordance with an embodiment of the invention. Surface information 320 is communicated to the graphics consumer component 230. While only one source of surface information 320 is depicted in FIG. 3, it should be understood that any number of sources of surface information are contemplated according to embodiments of the invention.

The surface information 320 can be generated by the generic surface manager component 220, as depicted in relation to FIG. 2. The graphics consumer component 230 can be a compositing desktop window manager (DWM), or other type of window manager that composes the surface information generated by the rendering component 210 into the render targets 240 and 250 on the desktop user interface on the computing device 100. The surface information 320 can be output by the generic surface manager component 220 in a defined graphics protocol that is compatible with the graphics consumer component 230.

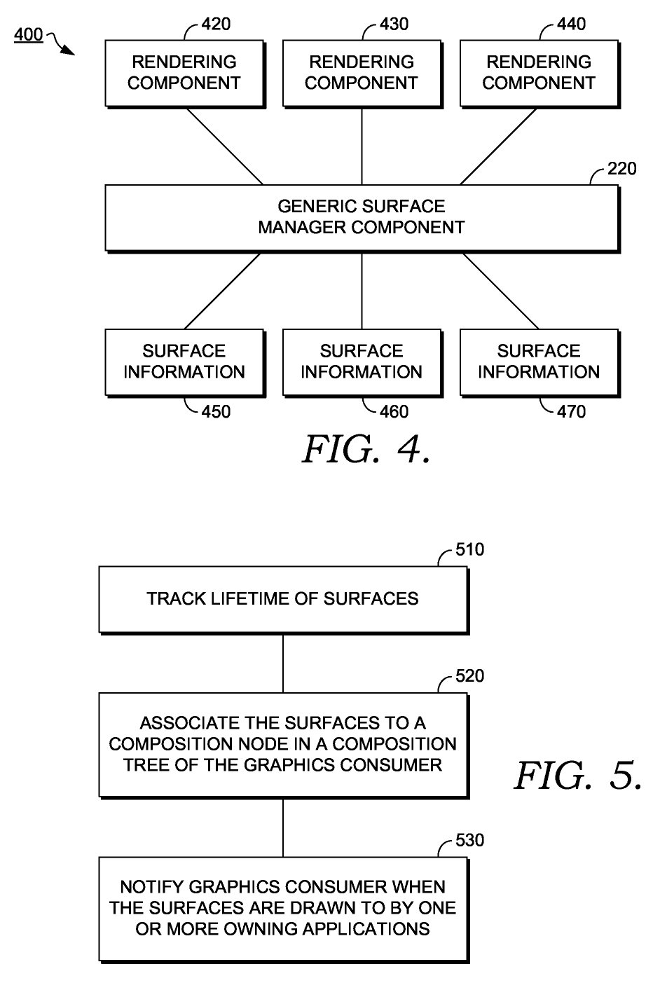

Turning now to FIG. 4, a diagram illustrating the communication of information between components of an exemplary system is presented according to an embodiment of the invention. The system 400 is comprised of rendering components 420, 430, and 440 communicatively connected to the generic surface manager component 220. Sources of surface information 450, 460, and 470 are communicatively connected to the generic surface manager component 220 as well.

As discussed in relation to FIG. 2 above, rendering components 420, 430, and 440 can be any type of application that generates graphical output for display on render targets 240 and 250. The graphical output can be referred to as surface information. The surface information can be generated according to one or more graphics protocols, such as DX and GDI.

With reference now to FIG. 5, a block diagram depicting a method for providing a generic interface between one or more surfaces and a graphics consumer is presented in accordance with an embodiment of the invention. At block 510, the lifetime of one or more surfaces are tracked. The surfaces can be the surface information generated by the rendering component, as described in regard to FIG. 2. Tracking the lifetime of the surface can comprise monitoring the surface information output by the rendering component 210 to determine when a surface is created and/or destroyed.

In block 520, the surfaces are associated to a composition node in a composition tree of the graphics consumer. The graphics consumer can be a graphics consumer component 230, such as a compositing desktop windows manager. The graphics consumer can compose the surfaces to generate the user interface on the computing device 100 by rendering the composition tree and associated composition nodes.

In block 530, the graphics consumer is notified when rendering occurs to the one or more surfaces by one or more owning applications. The generic surface manager component continually monitors the surface information generated by the rendering component, and, upon determining that a surface has been drawn to by rendering component 210, notifies the graphics consumer of the event. The graphics consumer can then render the composition tree to generate the user interface of the computing device 100.

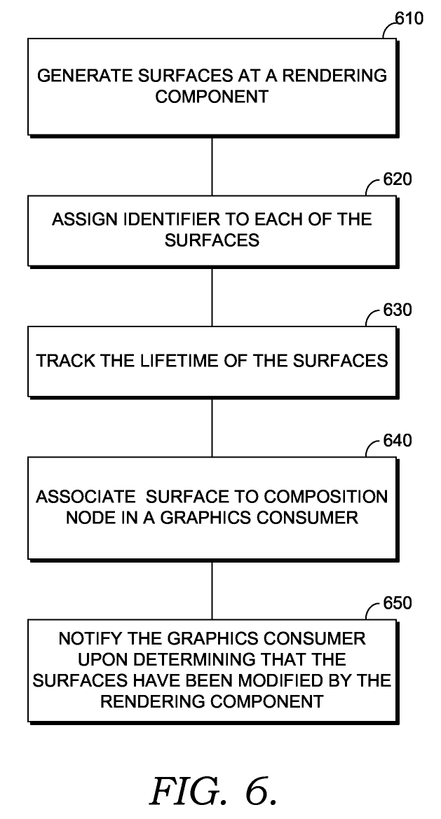

Turning to FIG. 6, a block diagram depicting a method for providing an interface between one or more surfaces and a graphics consumer is presented, according to an embodiment of the invention. The method begins at block 610 with the generation of surfaces at a rendering component. The surfaces can be generated as graphical output by the rendering component 210 according to one or more graphics protocols such as, DX or GDI,

In block 620, identifiers are assigned to the each of the surfaces generated in block 610. The identifiers can be a unique string of characters that serves to identify the particular surface.

The lifetime of the surfaces are tracked in block 630. Tracking the lifetime of the surface can comprise monitoring the surface information output by the rendering component 210 to determine when a surface is created and/or destroyed.

In block 640, at least one of the surfaces is associated to at least one composition node in a graphics consumer. The graphics consumer is notified upon a determination that a surface or surfaces have been modified by the rendering component. The graphics consumer can be a graphics consumer component 230, such as a compositing desktop windows manager. The graphics consumer can compose the surfaces to generate the user interface on the computing device 100 by rendering the composition tree and associated composition nodes.

In block 650, the graphics consumer is notified upon the generic surface manager component 220 determining that the surfaces have been modified by the rendering component. The generic surface manager component continually monitors the surface information generated by the rendering component, and upon determining that a surface has been modified by a rendering component 210 notifies the graphics consumer of the event. An example of a modification of the surface by the rendering component 210 is a situation where the rendering component 210 draws to the surface. The graphics consumer can then render the composition tree to generate the user interface of the computing device 100.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable storage media having computer-executable instructions embodied thereon for performing a method of providing a generic interface between one or more surfaces and a graphics consumer, the method comprising:
tracking the lifetime of the one or more surfaces, wherein the one or more surfaces are composed by the graphics consumer;
associating the one or more surfaces to a composition node in a composition tree in the graphics consumer; and
notifying the graphics consumer when rendering occurs to the one or more surfaces by one or more corresponding owning applications.

2. The media of claim 1, wherein tracking the lifetime of the one or more surfaces comprises tracking when the one or more surfaces are created or destroyed.

3. The media of claim 1, wherein the one or more surfaces are generated by one or more rendering components.

4. The media of claim 3, wherein the one or more rendering components are applications in an operating environment.

5. The media of claim 3, wherein the one or more surfaces are a logical memory store or space onto which graphical output from one or more rendering components is displayed in a user device.

6. The media of claim 1, wherein the graphics consumer is a compositing windows manager.

7. The media of claim 1, further comprising upon receiving a notification that the one or more surfaces are drawn to by the one or more corresponding owning applications, the graphics consumer renders the composition tree.

8. A system comprising:
a rendering component that generates surface information and communicates with a generic surface manager component;
a generic surface manager component that communicates with the rendering component to obtain surface information and then render it onto logical surfaces in accordance with a graphics protocol; and
a graphics consumer component for consuming the logical surfaces and rendering them as part of a composition tree.

9. The system of claim 8, wherein the generic surface manager component is an interface between the one or more rendering components and one or more graphics consumer components.

10. The system of claim 8, wherein the generic surface manager component generates a unique identifier for a surface and associates the surface with a composition node in a composition tree.

11. The system of claim 10, wherein the generic surface manager component notifies the graphics consumer component when one or more surfaces are drawn to by one or more rendering components.

12. The system of claim 11, wherein the graphics consumer component renders the composition tree upon receiving a notification from the generic surface manager component that one or more surface have been drawn to by one or more rendering components.

13. The system of claim 10, wherein the generic surface manager component monitors the lifetime of the surface.

14. The system of claim 13, wherein the monitoring of the lifetime of a surface comprises tracking when a surface is created or destroyed.

15. A method for providing an interface between one or more surfaces and a graphics consumer, the method comprising:
generating one or more surfaces at a rendering component;
assigning an identifier to each of the one or more surfaces;
tracking the lifetime of the one or more surfaces;
associating at least one of the one or more surfaces to at least one composition node in a graphics consumer;
upon determining that the one or more surfaces have been modified by the rendering component, notifying the graphics consumer.

16. The method of claim 15, wherein the rendering components comprise one or more owning applications in an operating environment.

17. The method of 16, wherein the one or more surfaces are generated in accordance with at least two different graphics protocols.

18. The method of claim 15, wherein one or more composition nodes comprise a composition tree.

19. The method of claim 18, wherein upon receiving the notification that the one or more surfaces have been modified by the rendering component the graphics consumer renders the composition tree.

20. The method of claim 19, wherein the notification includes the identifier associated with each of the one or more surfaces.
